(19) United States
(12) Patent Application Publication
(10) Pub. No.: US 2025/0147954 A1
(43) Pub. Date: May 8, 2025

(54) DATABASE SEARCH BASED ON MACHINE LEARNING BASED LANGUAGE MODELS

(71) Applicant: Maplebear Inc., San Francisco, CA (US)

(72) Inventors: Christopher Billman, Chicago, IL (US); Benjamin Knight, Oakland, CA (US); Kenneth Jason Sanchez, Orange, CA (US); Matthew Negrin, Brooklyn, NY (US); Licheng Yin, Mississauga (CA); Rebecca Riso, Croton-On-Hudson, NY (US)

(21) Appl. No.: 18/936,854

(22) Filed: Nov. 4, 2024

Related U.S. Application Data
(60) Provisional application No. 63/595,729, filed on Nov. 2, 2023.
(60) Provisional application No. 63/547,535, filed on Nov. 6, 2023.

(51) Int. Cl. G06F 16/242; G06F 16/2455

(52) U.S. Cl. CPC G06F 16/243; G06F 16/2455

(57) ABSTRACT

An online system receives information describing a set of items requested by a user and an indication via a chat interface that a particular item needs replacement. The online system generates one or more prompts configured to request a machine learned language model to identify the particular item that needs replacement and to identify one or more replacement items for the particular item. The online system receives a set of item identifiers from the machine learned language model and selects a replacement item from a database based on the set of item identifiers. The online system may also receive an order and a communication history associated with a user including a message with a request to modify the a. The online uses the machine-learning language model to map the request type to the set of API requests for updating the order to reflect the request from the user.

### CROSS-REFERENCE TO RELATED APPLICATIONS

This application claims the benefit of U.S. Provisional Application No. 63/595,729, filed on Nov. 2, 2023, and U.S. Provisional Application No. 63/547,535, filed on Nov. 6, 2023, each of which is incorporated by reference herein in its entirety.

### BACKGROUND

One or more aspects described herein relate generally to database systems and more specifically to performing database searches using a natural language interface based on a machine learned language model.

Online systems store data and metadata describing assets in a database, for example, a relational database. Such databases are queried using database query languages such as structured query language (SQL). However, querying a database for specific information requires knowledge of the schema of the database storing the data and requires expertise in database query languages. An application may provide a user interface for inspecting the data of the catalog. However, such applications are typically programmed for specific use cases and present a special purpose interface that provides access to a limited amount of data. A user of such an application may not be able to access data that the application was not designed to access. For example, extending the application to allow access to information that the application was not designed for requires modifying the instructions of the application and is a cumbersome process. Therefore, conventional approaches either require strong database expertise from the user or are restrictive in terms of the information that a user can access.

### SUMMARY

An online system, according to one or more embodiments, receives information describing a set of items requested by a user. The online system receives an indication via a chat interface that a particular item needs replacement. The online system generates a first prompt configured to request a machine learned language model to identify the particular item that needs replacement. The first prompt specifies conversations performed by the user via the chat interface. The online system sends the first prompt to the machine learned language model and receives a response identifying the particular item from the machine learned language model. The online system generates a second prompt configured to request the machine learned language model to identify one or more replacement items for the particular item. The online system receives a response identifying a set of item identifiers from the machine learned language model, each item identifier identifying the item in a database. The online system selects a replacement item from a database based on the set of item identifiers.

According to one or more embodiments, the online system receives an order representing a transaction from a user and a communication history between a user and a picker for the order including at least one message with a request from the user to modify the order. The online concierge system encodes a prompt for input to a machine-learning language model. The prompt specifies at least one item of the order and the message with the request from the user. The online concierge system provides the prompt to a model serving system for execution by the machine-learning language model. The model maps the request type to the set of API requests for updating the order to reflect the request from the user. The online concierge obtains the set of API requests from the model serving system and invokes the obtained set of API requests to update information on the order of the user.

### BRIEF DESCRIPTION OF THE DRAWINGS

FIG. 1A illustrates an example system environment for an online system 140, in accordance with one or more embodiments.

FIG. 1B illustrates an example system environment for an online system 140, in accordance with one or more embodiments.

FIG. 2 illustrates an example system architecture for an online system 140, in accordance with one or more embodiments.

FIG. 3 shows a flowchart illustrating a process for determining replacement items for a user based on natural language interactions with the user, according to one or more embodiments.

FIG. 4 is a flowchart for updating an order in response to a user communication with an adjustment to the order, in accordance with one or more embodiments.

### DETAILED DESCRIPTION

An online system provides a natural language interface, for example, an online chat interface that allows users to make requests related to assets stored in a catalog. The online system translates the requests made using the natural language interface to structured queries and commands for a catalog storing information describing the catalog. The online system uses a machine learned language model, for example, a large language model (LLM) to analyze the natural language requests and to convert the natural language requests to structured queries for accessing information from the catalog. The techniques disclosed herein provide a technical improvement over current techniques by providing an improved user interface for accessing structured data stored in a catalog and providing high degree of accuracy of results obtained from structured catalog data using natural language queries.

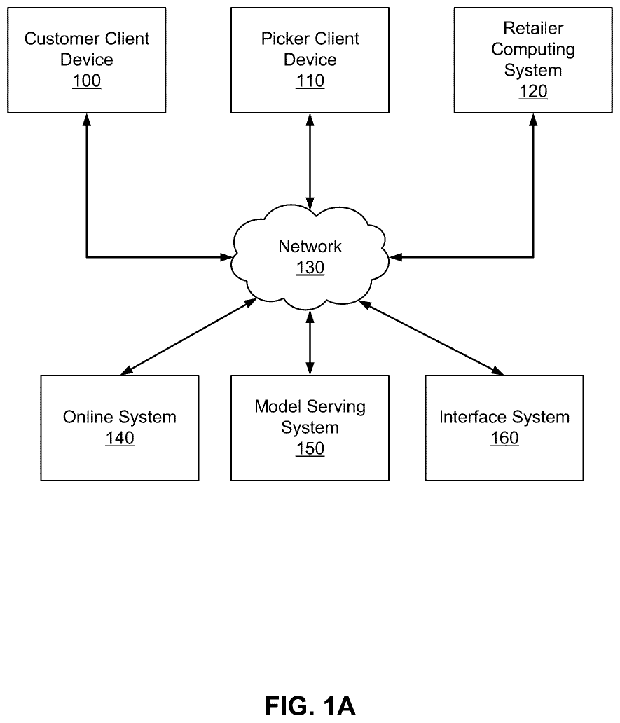

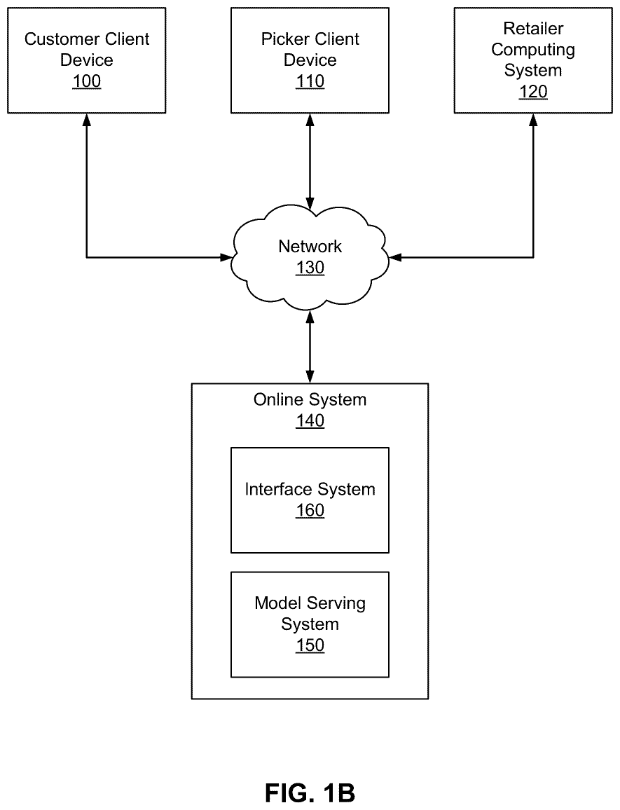

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully autonomous robot may collect items in a retailer location for an order and an autonomous vehicle may deliver an order to a customer from a retailer location.

According to one or more embodiments, a picker and a customer interact with each other using a natural language-based chat interface. A customer may also be referred to herein as a user or an end user. Often, an item requested by the customer is not available at a retailer location. The customer may use the natural language based online chat interface, to specify one or more replacement items that can be substituted instead of the item originally requested. Requests made using a natural language interface are typically unstructured and may not map to specific items in the catalog. For example, assume that a particular type of soda originally requested by the customer is not available at the retailer location. The customer may request via the online chat interface that “any type of diet soda would work instead.” However, such a user request is not specified using the query interface of the catalog and may not specify items stored in the catalog. For example, the natural language request does not identify specific items using identifiers used by the catalog.

The online system 140 uses a machine learned language model to determine one or more structured queries to access the correct information requested by the customer. A system that obtains inaccurate results based on natural language queries results in poor user experience and results in inefficiencies in the overall process. For example, the picker may have to return the incorrect replacement items that may be provided to a customer resulting in additional steps in the overall process and use of additional resources of the online system 140. The system according to one or more embodiments uses a machine learned language model to improve the accuracy of results obtained from natural language queries, thereby improving the efficiency of execution of the overall process as well as providing improved user interface and user experience. A machine learned language model is also referred to herein as a machine learning based language model or machine learning language model.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

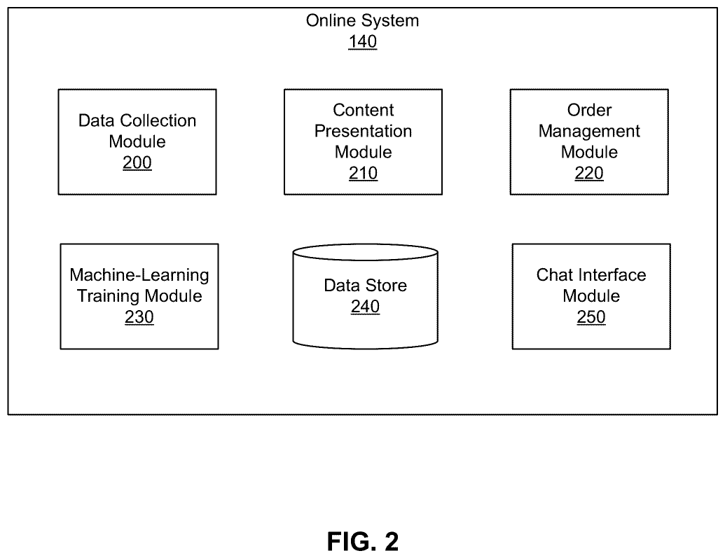

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2A.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. The terms LLM and machine learned language models may be user interchangeably herein. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 collects comments from multiple users. The online system 140 receives and processes queries based on the comments. Specifically, the online system 140 prepares one or more prompts for input to the model serving system 150 based on the user queries. The prompts request information representing insights based on the comments as well as evidence for the insight. The evidence identifies specific comments that were used to gain the insight. The online system 140 receives a response to the prompt from the model serving system 150 based on execution of the machine-learned model using the prompt. The online system 140 obtains the response and provides the requested information to the user.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

The online system 140 receives comments from users and provides them to the interface system 160. According to one or more embodiments, the interface system 160 includes an index that comprises data structures that store information obtained from external sources, for example, a corpus of unstructured text representing user comments. Examples of such an index include GPT Index and LlamaIndex. The index allows the system to connect the corpus of information with a machine-learned language model so that the answers to a prompt are based on the knowledge of the trained machine-learned language model as well as the information stored in the corpus. Accordingly, in the system as disclosed the answers to prompts requesting insights are based on knowledge of the trained machine-learned language model as well as the information stored in the corpus or user comments.

For an online shopping application, the online system 140 may receive comments from various users such as customers and personal shoppers. Specifically, the online system 140 provides the comments received from users to the interface system 160. The online system 140 provides a query received from a user to the interface system 160. The online system 140 receives a response to the prompt from the interface system 160 based on execution of the machine-learned model in the model serving system 150 using prompts generated by the interface system 160. The online system 140 obtains the response and provides the requested information to the user.

In one or more embodiments, the online system 140 is connected to the interface system 160. As noted above, the interface system 160 may interact with users using natural language text to receive user comments. The interface system 160 receives external data from the online system 140 (for example, user comments) and builds a structured index over the external data using, for example, another machine-learned language model or heuristics.

The interface system 160 obtains one or more responses from the model serving system 150 and synthesizes a response to the query on the external data. While the online system 140 can generate a prompt for a machine learned language model using the external data as context, the amount of information in the external data may exceed prompt size limitations of the machine-learned language model. The interface system 160 resolves prompt size limitations by generating a structured index of the data. The interface system 160 also offers data connectors to external data sources.

The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of information obtained from the index as contextual information for the query. The prompt requests information that represents insight based on comments, for example, insight representing a reason why users are taking a specific action. Examples of actions taken by users may be users leaving an organization, users preferring a particular retailer compared to another retailer that offers similar products/services, characteristics of a product that users are typically interested in, and so on. The prompts also request evidence for any insights, for example, comments that were used to generate the insight.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with one or more embodiments. The system architecture illustrated in FIG. 2A includes a data collection module 200, a content presentation module 210, an order management module 220, a machine learning training module 230, a data store 240, and a chat interface module 250. Alternative embodiments may include more, fewer, or different components from those illustrated in FIG. 2A, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. For example, the machine learning training module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data stored in the data store 240 represents a catalog that describes the asset inventory of a retailer. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine learning training module 230 may further train parameters of the machine-learned model based on data specific to the online system 140 stored in the data store 240. As an example, the machine learning training module 230 may obtain a pre-trained transformer language model and further fine tune the parameters of the transformer model using training data stored in the data store 240. The machine learning training module 230 may provide the model to the model serving system 150 for deployment.

The chat interface module 250 provides a natural language interface that allows users to interact with a system or with other users. The chat interface 250 may receive a sequence of interactions between two entities, for example, users, chatbots, and so on. The chat interface module 250 receives natural language requests from the user and processes them using a machine learned language model, for example, a large language model (LLM). According to one or more embodiments, the chat interface module 250 generates a prompt for the machine learned language model and sends the prompt to the machine learned language model for execution. The machine learned language model may be a component of the online system 140 or may be a separate system that provides the functionality of a machine learned language model as a service. Accordingly, a message including the prompt may be sent by the chat interface module 250 of the online system 140 to an external system offering the machine learned language model as a service. The external system executes the machine learned language model and sends the result in a response to the requestor, i.e., the online system 140. The chat interface module 250 of the online system 140 receives the response from the external system and uses the response for any subsequent processing based on the result of execution of the machine learned model.

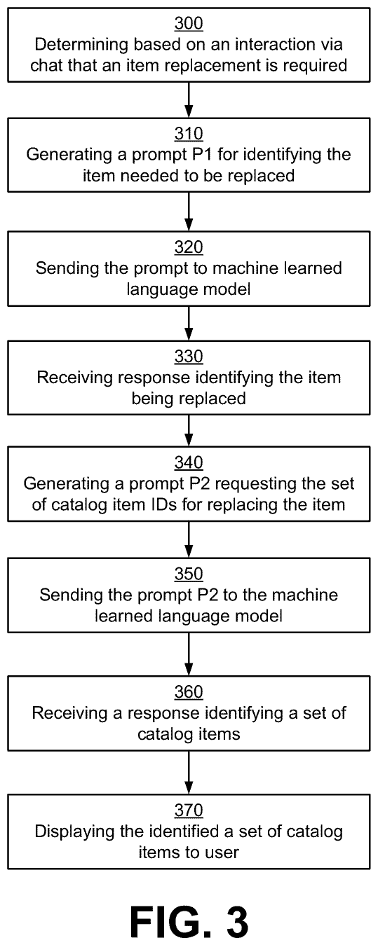

The prompt generated by the chat interface module 250 may request the machine learned language model to provide a response using a nested object data structure, for example, a nested object represented using a JavaScript Object Notation (JSON) format. Accordingly, the chat interface module 250 uses the machine learned language model to convert unstructured natural language questions received from the user via the chat interface into structured queries for the catalog. Details of the process used for converting natural language requests to catalog queries are further illustrated in FIG. 3 and described in connection with FIG. 3.

### Determining Replacement Items

FIG. 3 shows a flowchart illustrating a process for determining replacement items for a user based on natural language interactions with the user, according to one or more embodiments. The steps shown are indicated as being performed by a system, for example, the online system 140 and may be performed by one or more modules shown in FIG. 2, for example, by the chat interface module 250. Steps shown in FIG. 3 may be performed in an order different from that indicated in the flowchart shown in FIG. 3.

A chat interface is used for natural language interactions between a picker (also referred to as a personal shopper) and a customer (also referred to as a user). In step 300, the chat interface module 250 receives an indication that the customer needs a replacement item. The indication that the customer needs a replacement item may be provided by the picker upon determining that one of the items requested by the customer is missing at a retailer location where the picker is acquiring the items requested by the customer.

In step 310, the chat interface module 250 generates a prompt P1 for requesting a machine learned language model to identify the item needed to be replaced. According to one or more embodiments, the prompt P1 specifies the following information along with a request to identify one or more replacement items corresponding to an item requested by the customer: the chat history of the customer for that order including conversation between the picker and the customer; order information for the order including items ordered, customer location, time of order, retailer information and so on; embeddings representing past customer behavior; and so on.

In step 320, the chat interface module 250 sends the prompt P1 to the machine learned language model for execution. In step 330, the chat interface module 250 receives a response from the machine learned language model. The response identifies the item being replaced. The system extracts the item being replaced from the response. For example, if the response is a JSON object, the chat interface module 250 parses the JSON object to identify the item being replaced.

In step 340, the chat interface module 250 generates another prompt P2 for requesting a machine learned language model to identify a set of catalog items that may be used as replacement for the item. According to one or more embodiments, the prompt P2 specifies the following information along with a request to identify one or more specific replacement items corresponding to an item requested by the customer: the chat history of the customer for that order including conversation between the picker and the customer; order information for the order including items ordered, customer location, time of order, retailer information and so on; embeddings representing past customer behavior; list of similar items their description, and their catalog ID returned by the catalog; and so on. The chat interface module 250 may determine the list of similar items by performing searches using the catalog.

In step 350, the chat interface module 250 sends the prompt P2 to the machine learned language model for execution. The machine learned language model is executed with the prompt P2 as input to generate a response. In step 360, the chat interface module 250 receives the response from the machine learned language model. The response identifies a set of catalog items, for example, by specifying a set of catalog item IDs (identifiers).

In step 370, the chat interface module 250 provides the set of catalog items to the customer, for example, via a user interface that allows the user to select one or more items from a given list. The chat interface module 250 receives the user selection and notifies the picker of the user selection accordingly. The picker uses the identified replacement item instead of the item originally requested by the user.

According to one or more embodiments, the chat interface module 250 automatically replaces the original item with a particular replacement item in a data structure representing the shopping cart. According to an embodiment, the chat interface module 250 requests the machine learning model to rank the replacement items in an order based on their degree of match with the item being replaced. The chat interface module 250 selects an item from the set of replacement items returned by the machine learning based language model based on the ranking received from the machine learning based language model. According to an embodiment, the online system trains a machine learning based model configured to receive two items as input and return a matching score indicating a degree of match between the two items. The chat interface module 250 uses this machine learning based model to select the best replacement item. For example, the chat interface module 250 provides a pair comprising the item being replaced and each replacement item received from the machine learned language model and determines a matching score for each pair. The chat interface module 250 selects a replacement item based on the matching score, for example, by picking the replacement item corresponding to the pair with the highest matching score. The machine learning model is trained based on known pairs of matching items that may be provided by experts or based on previously approved replacement items by users that may be extracted from logs of the online system, for example, transaction logs that store details of various orders received and orders executed.

According to one or more embodiments, the chat interface module 250 implements a human in the loop model that provides the list of replacement items determined by the chat interface module 250 to a user, for example, the picker. The picker validates the list of replacement items. For example, if one or more items are determined to be unsuitable as replacements of the item originally requested, the picker may delete them from the list of replacement items. The online system may use the information describing the deleted items and the items approved as training data that may be used as negative training data or positive training data respectively to train either a machine learning based model that determined matching score of to fine tune or refine the machine learned language model. To fine tune or refine the machine learned language model, the online system may generate sentences stating, “X is a good replacement for Y,” or “X is not a good replacement for Y,” where X and Y are items. These sentences are provided as input for training the machine learned language model.

According to one or more embodiments, the picker takes a picture of one or more shelves of the retailer for determining the replacement items that are currently available at the retailer. The chat interface module 250 may generate a multimodal prompt to the LLM. The multimodal prompt may include information in various formats, such as photos, images, videos, frames of video, etc. Item descriptions, catalogs and information of items are often provided by retailers. The information may include unstructured data in various formats, and may be flawed and/or insufficient. For example, if the machine learned language model is configured to receive and process images as input, the images of the shelfs may be included in the prompt P2 provided to the machine learned language model. Alternatively, a different machine learned language model trained to perform object recognition in images is executed to process the images to determine the list of items that are currently available at the retailer. The list of items currently available may be provided as part of the prompt P2 to the machine learned language model. Alternatively, the chat interface module 250 determines the available items by invoking APIs (application programming interfaces) provided by the retailer that allows the system to determine whether an item is currently available at the retailer location. According to one or more embodiments, the system highlights the replacement item selected by the customer in the image(s) taken by the picker and provides the highlighted replacement item to the picker. This provides a user-friendly user interface for the picker to find where the requested replacement item is available in the retailer location.

### Adjusting Orders Based on Communication History

The order adjustment module 225 tracks adjustments to an order made by the user and updates the order to reflect those updates. The order adjustment module 225 stores and maintains a communication history regarding each order between users of the online system 140 and the picker fulfilling the order. A user initiates communication with a picker by submitting an order to the online system 140, which the picker accepts. The order supplies initial instructions to the user, for example which items to select and how many of each item to select. If the user makes no other updates or modifications to a pending order, the communication history for that order is limited to the order placed by the user. Alternatively, if the user does send additional messages to the picker via the communication interface, the communication history for that order is updated to reflect the additional messages.

As described above, conventionally when a user attempts to modify a submitted order, the user would have to manually update their order by navigating through a graphical user interface through an arduous sequence of options to update their order. For example, a user attempting to add an item to an existing order may perform a series of clicks to navigate to a specific location on the website, search for the item, and click a button to add the item to the order. As another example, a user attempting to change the quantity for a particular item in an order may have to navigate to the ordering interface and click on the item to edit the ordered quantity. As the user navigates through the series of options, the online system 140 executes a series of API requests that ultimately result in the online system 140 updating the order.

Alternatively, the user may message the picker assigned to the order to further modify the order through, for example, a chat window. For example, a user may message a picker that they would like to replace the requested brand of cereal with a different brand. Often times, pickers have significant discretion in following the user's instructions that are not officially part of the order. For example, the picker may ignore the user's messages in the communication history or refrain from reading the communication. However, if the user updates their official order to reflect their replacement, the picker is more likely to comply with the replacement. However, to update the order, as described above, the user may navigate through an interface by selecting the order, selecting the requested brand of cereal, selecting a substitute option, selecting the replacement brand of cereal, and confirming the modification. The series of selections at the user interface trigger a series of API requests, which result in the order viewed by the picker reflecting the replacement.

In one or more embodiments, the order adjustment module 225 automatically generates one or more API calls or requests from free text (e.g., chat history between user and picker) in conjunction with one or more trained LLM's deployed by the model serving system 150. The free text includes information by the user on desired changes to the user's order—the generated API calls when processed modify the user's order with the desired changes. The order adjustment module 225 executes the series of API requests necessary to perform the change or update based on text in the communication history of the order. Because a user and a picker may freely communicate with each other regarding an order, the communication history for the order may be a freeform string of messages.

Accordingly, in one or more embodiments, the order adjustment module 225 transmits (i) the communications history (e.g., chat history) for the given order, (ii) order context, (iii) information describing the expected picker action, (iv) communication history for a population of historical orders, and/or (v) other contextual information, and a request to infer one or more types of API calls to invoke for order modification to the model serving system 150 in the form of a prompt. A first LLM analyzes the communication history and extracts requests, modifications, or adjustments to the order made by the user. The trained LLM extracts text from each message sent by the user.

The first LLM classifies the extracted text for each message into a request type. In one or more instances, the request type indicates one or more types of API calls the first LLM determines should be invoked to perform the desired change described in the communication history of the user. For example, an example request type might be to update replacement items for an item in the order, and an example API call type may be the “user_choice_replacements” API call. As another example, an example request type might be to change the quantity of an item in the order, and an example API call type may be the “change_item_quantity” API call.

Afterwards, for each identified API call type, the order adjustment module 225 transmits a prompt including a request to infer the API call specific to the user's order to a second LLM deployed by the model serving system 150. The first LLM and the second LLM may be the same or different. In one instance, the prompt may also include examples of how to invoke the particular API call that includes an example chat between a user and picker and an example API call for that example chat.

The order adjustment module 225 provides the output to an appropriate module that executes the one or more API requests to generate an updated order reflecting the request made by the user. In one instance, the format of the output is XML or JSON. When executed, the set of API requests update the order to reflect the user's request by, for example, changing values in a database maintained by the online system 140 in conjunction with the ordering interface, and the like, such that the ordering information for the user's order is updated and reflected in the application for the online system 140.

As an illustrative example, a user may place an order for: 16 oz blueberries, 1 gallon of milk, and 1 32 oz box of cereal. After placing the order, the user may send a message to the picker via the communication interface stating “Hi, can you buy two gallons of milk for me.” The first LLM may extract text information from the message and classify the user's message as a request to change quantity. The first LLM identifies a combination of API request types that would be executed if the user were to manually update the order to reflect the request to change quantity, hereafter referred to as a “change quantity protocol.” As an example, the API request type for the request type may be identified as “change_item_quantity.” The order adjustment module 225 receives the change quantity protocol and obtains the prompt to the second LLM requesting the API call that should be made for the order. For example, the API call may be “change_item_quantity: {milk: ‘2 gal’}” that is propagated with the data specific to the user's request. The online system 140 executes the necessary API requests to update the user's order without any further input from the user beyond the message in the communication history.

Continuing from the above example, the user may send a message to the picker via the communication interface stating, “if they don't have blueberries, raspberries or blackberries are also good for me.” The first LLM may extract text information from the message and classify the user's message as a substitution (or replacement) request. The first LLM identifies a combination of API request types that would be executed if the user were to manually update the order to reflect the substitution request, hereafter referred to as a “substitution protocol.” As an example, the API request type for the request type may be identified as “user_choice_replacements.” The order adjustment module 225 receives the substitution protocol and obtains the prompt to the second LLM requesting the API call that should be made for the order. For example, the API call may be “user_choice_replacements: {‘blueberries’: [‘raspberries’, ‘blackberries’]}” that is propagated with the data specific to the user's request. The online system 140 and executes the necessary API requests to update the user's order without any further input from the user beyond the message in the communication history.

Continuing from the above example, the user may send a message to the picker via the communication interface stating, “can you take a picture of possible replacements if my cereal isn't there?” The first LLM may extract text information from the message and classify the user's message as an image request. The LLM identifies a combination of API request types that would be executed if the user were to manually update the order to reflect the image request, hereafter referred to as an “image protocol.” As an example, the API request type for the request type may be identified as “request_image.” The order adjustment module 225 receives the image protocol and obtains the prompt to the second LLM requesting the API call that should be made for the order. For example, the API call may be “request_image: {‘ABC Cereal’: True}” that is propagated with the data specific to the user's request and executes the necessary API requests to update the user's order without any further input from the user beyond the message in the communication history.

In one or more embodiments, when the API calls have been processed to reflect changes to an order, the online system 140 first presents the proposed changes to the user or the picker, and only proceeds to modify the order when approval is received from the user. For example, a user may request addition of garlic to the user's existing order, and a pound of garlic, which is likely too large for the individual user's consumption may be proposed to be added. The user can reject the proposed modification and the order adjustment module 225 may correct the proposed modification. In this manner, the online system 140 allows “human-in-the-loop” mechanisms to improve compliance when orders are modified.

In some embodiments, the LLM at the model serving system 150 generates a suggested response for the picker to send based on a message received from the user. The LLM may be trained based on historical communications between a shopper and a picker labeled as having an acceptable picker response. The LLM may transmit the suggested response to the order adjustment module 225 and the order adjustment module 225 may present the generated message as an alternative response for the picker to send.

In embodiments where the user sends a message with a replacement request, the LLM may generate a replacement suggestion for the user based on preferences and attributes recorded for the user. In such embodiments, the order adjustment module 225 may generate and maintain an embedding representing the user's preferences and historical orders and include the customer embedding in the prompt transmitted to the LLM. For example, for an older adult, the LLM may suggest a bottle of wine as a replacement for one of the user's selected beverage items. However, the LLM may suggest a bottle of soda as a replacement for a user who is a freshman in college.

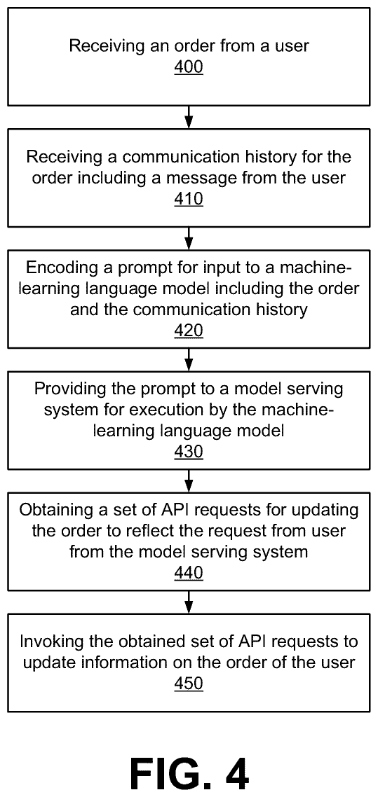

FIG. 4 is a flowchart for a method of inferring whether an automated response or action can be generated for a message, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 receives 400 an order from a user and receives 410 a communication history for the order including a message from the user. The online system 140 encodes 420 a prompt for a machine-learning language model. The prompt may specify the order itself and at least one message of the communication history. The online system 140 provides 430 the prompt to a model serving system for execution by the machine-learning language model. The machine-learning language model extracts text and other features from messages in the communication history to identify requests submitted by the user and classify each request to a request type. For each identified request, the response received by the online system specifies the request type and a set of API requests for the online system 140 to execute to automatically update the order received from the user to reflect the request. The online system obtains 440 a set of API requests from the model serving system 150 for updating the order to reflect the request from the user. The online system 140 invokes 450 the obtained set of API requests to update information on the order of the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
at a computer system comprising a processor and a computer-readable medium:
receiving information describing a set of items requested by a user;
receiving an indication via a chat interface that a particular item needs replacement;
generating a first prompt for a machine learned language model, the first prompt configured to request the machine learned language model to identify the particular item that needs replacement, the first prompt specifying conversations performed by the user via the chat interface;
inputting the first prompt to the machine learned language model to output a response identifying the particular item;
generating a second prompt for the machine learned language model, the second prompt configured to request identification of one or more replacement items for the particular item;
inputting the second prompt into the machine learned language model to output a response identifying a set of item identifiers, each item identifier identifying a corresponding replacement item in a database;
selecting a replacement item from a database based on the set of item identifiers; and
sending a message describing the selected replacement item.

2. The method of claim 1, further comprising:
generating a database query for the database based on the set of item identifiers; and
executing the database query to obtain the set of item identifiers as a result of executing the database query.

3. The method of claim 1, wherein selecting the replacement item based on the set of item identifiers comprises:
providing a set of items identified based on the set of item identifiers via a user interface; and
receiving a selection of the replacement item via the user interface.

4. The method of claim 1, wherein selecting the replacement item based on the set of item identifiers comprises:
for each replacement item, determining a matching score indicating a degree of match between the particular item and the replacement item, the matching score determined based on a machine learning model trained to receive a pair of input items and output a matching score indicating a degree of match between the items of the pair of input items; and
selecting a replacement item based on the matching scores.

5. The method of claim 1, wherein the machine learned language model is a large language model.

6. The method of claim 1, further comprising:
training the machine learned language model based on training data including positive training data comprising sentences identifying pairs of items that match and negative training data comprising sentences identifying pairs of items that fail to match.

7. The method of claim 6, wherein the pairs of items that match are determined based on user feedback approving a replacement item recommended for an input item and negative training data determined based on user feedback rejecting a replacement item recommended for an input item.

8. The method of claim 1, further comprising:
receiving a communication associated with a transaction;
receiving a natural language request from the user to modify the transaction; and
responsive to receiving the natural language request from the user, using the machine learned language model for generating a set of application programming interface (API) requests for updating the transaction to reflect the request from the user.

9. The method of claim 8, wherein the prompt is a first prompt, wherein generating a set of application programming interface (API) using the machine learned language model comprises:
encoding a second prompt for input to one or more machine-learning language models, the second prompt specifying at least one of: the transaction or the communication associated with a transaction; and
providing the prompt to the machine learned language model.

10. The method of claim 9, further comprising:
obtaining, from the machine learned language model, the set of API requests for updating the transaction to reflect the request from the user; and
invoking the obtained set of API requests to update the transaction.

11. A non-transitory computer readable storage medium, storing instructions that when executed by one or more computer processors cause the one or more computer processors to perform steps comprising:
receiving information describing a set of items requested by a user;
receiving an indication via a chat interface that a particular item needs replacement;
generating a first prompt for a machine learned language model, the first prompt configured to request the machine learned language model to identify the particular item that needs replacement, the first prompt specifying conversations performed by the user via the chat interface;
inputting the first prompt to the machine learned language model to output a response identifying the particular item;
generating a second prompt for the machine learned language model, the second prompt configured to request identification of one or more replacement items for the particular item;
inputting the second prompt into the machine learned language model to output a response identifying a set of item identifiers, each item identifier identifying a corresponding replacement item in a database;
selecting a replacement item from a database based on the set of item identifiers; and
sending a message describing the selected replacement item.

12. The non-transitory computer readable storage medium of claim 11, further comprising:
generating a database query for the database based on the set of item identifiers; and
executing the database query to obtain the set of item identifiers as a result of executing the database query.

13. The non-transitory computer readable storage medium of claim 11, wherein selecting the replacement item based on the set of item identifiers comprises:
providing a set of items identified based on the set of item identifiers via a user interface; and
receiving a selection of the replacement item via the user interface.

14. The non-transitory computer readable storage medium of claim 11, wherein selecting the replacement item based on the set of item identifiers comprises:
for each replacement item, determining a matching score indicating a degree of match between the particular item and the replacement item, the matching score determined based on a machine learning model trained to receive a pair of input items and output a matching score indicating a degree of match between the items of the pair of input items; and
selecting a replacement item based on the matching scores.

15. The non-transitory computer readable storage medium of claim 11, further comprising:
training the machine learned language model based on training data including positive training data comprising sentences identifying pairs of items that match and negative training data comprising sentences identifying pairs of items that fail to match.

16. The non-transitory computer readable storage medium of claim 15, wherein the pairs of items that match are determined based on user feedback approving a replacement item recommended for an input item and negative training data determined based on user feedback rejecting a replacement item recommended for an input item.

17. The non-transitory computer readable storage medium of claim 11, further comprising:
receiving a communication associated with a transaction;
receiving a natural language request from the user to modify the transaction; and
responsive to receiving the natural language request from the user, using the machine learned language model for generating a set of application programming interface (API) requests for updating the transaction to reflect the request from the user.

18. The non-transitory computer readable storage medium of claim 17, wherein the prompt is a first prompt, wherein generating a set of application programming interface (API) using the machine learned language model comprises:
encoding a second prompt for input to one or more machine-learning language models, the second prompt specifying at least one of: the transaction or the communication associated with a transaction; and
providing the prompt to the machine learned language model.

19. The non-transitory computer readable storage medium of claim 18, further comprising:
obtaining, from the machine learned language model, the set of API requests for updating the transaction to reflect the request from the user; and
invoking the obtained set of API requests to update the transaction.

20. A computer system comprising:
one or more computer processors; and
a non-transitory computer readable storage medium, storing instructions that when executed by the one or more computer processors cause the one or more computer processors to perform steps comprising:
receiving information describing a set of items requested by a user;
receiving an indication via a chat interface that a particular item needs replacement;
generating a first prompt for a machine learned language model, the first prompt configured to request the machine learned language model to identify the particular item that needs replacement, the first prompt specifying conversations performed by the user via the chat interface;
inputting the first prompt to the machine learned language model to output a response identifying the particular item;
generating a second prompt for the machine learned language model, the second prompt configured to request identification of one or more replacement items for the particular item;
inputting the second prompt into the machine learned language model to output a response identifying a set of item identifiers, each item identifier identifying a corresponding replacement item in a database;
selecting a replacement item from a database based on the set of item identifiers; and
sending a message describing the selected replacement item.
